(19) United States
(12) Patent Application Publication
(10) Pub. No.: US 2024/0221533 A1
(43) Pub. Date: Jul. 4, 2024

(54) VIRTUAL REALITY TRAINING TOOL FOR INDUSTRIAL EQUIPMENT AND PROCESSES

(71) Applicant: SAUDI ARABIAN OIL COMPANY, Dhahran (SA)

(72) Inventor: Syed Munib HADI, Dhahran (SA)

(73) Assignee: SAUDI ARABIAN OIL COMPANY, Dhahran (SA)

(21) Appl. No.: 18/147,539

(22) Filed: Dec. 28, 2022

(51) Int. Cl. G09B 19/00; G06F 3/01; G09B 5/06

(52) U.S. Cl. CPC G09B 19/003; G06F 3/011; G09B 5/06

(57) ABSTRACT

The present disclosure relates to industrial training. In some examples, a method includes providing, on a device, a simulation that includes a virtual environment for virtual industrial training, and in response to user selection on a selection device: selecting a mode of operation for the virtual environment, selecting an industrial plant, identifying industrial equipment in the virtual environment, rendering a model of the industrial equipment in the virtual environment, and providing equipment description for the model of the industrial equipment in the virtual environment.

### FIELD OF THE DISCLOSURE

This disclosure relates generally to virtual reality (VR), and more particularly, to VR training and tool for industrial equipment and processes.

### BACKGROUND OF THE DISCLOSURE

Training is teaching, or developing in oneself or others, any skills and knowledge or fitness that relate to specific useful competencies. Training has specific goals of improving one's capability, capacity, productivity, and/or performance. It forms the core of apprenticeships and provides the backbone of content at institutes of technology (also known as technical colleges or polytechnics) and other entities, such as companies. In addition to the basic training required for a trade, occupation or professional training may continue beyond initial competence to maintain, upgrade and update skills throughout working life.

Difficulties in training arise in industrial technologies such as a fossil fuel industry (e.g., oil and/or gas industry), as a fresh or new trainee (a person being trained) is generally inexperienced and conceptually grasping or visualizing oil and gas equipment and processes is difficult. Bringing industrial equipment into a training facility (e.g., a building) is not realistic nor feasible for some types of industrial equipment. Some existing fossil fuel industry programs rely on hands-on experience and require that the trainee be on site (e.g., an oil production plant or gas processing plant). However, for such inexperienced learners, onsite training can pose a risk to the trainee, or an industrial operator. Additionally, in some instances, to provide proper industrial equipment training, industrial operators have to stop industrial operation, which may not be possible (e.g., resulting in loss or damage to equipment or product), or too costly for the industrial operator.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method for industrial virtual training can include providing, on a device, a simulation that includes a virtual environment, and in response to user selection on a selection device: selecting a mode of operation for the virtual environment, selecting an industrial plant, identifying industrial equipment in the virtual environment, rendering a model of the industrial equipment in the virtual environment, and providing equipment description for the model of the industrial equipment in the virtual environment.

In another embodiment consistent with the present disclosure, a system for virtual industrial training can include a rendering system that includes a rendering controller and a game engine. The rendering controller can be configured to provide instructions and content from a content repository for simulating a virtual environment. The game engine can be configured to run the instructions and the content to simulate the virtual environment with one or models of an industrial plant and/or equipment. The rendering controller can be configured to receive user selection requests from one or more selection devices and update the virtual environment to allow a user to learn about the industrial plant and/or equipment.

In a further embodiment consistent with the present disclosure, a non-transitory computer-readable medium can include machine-readable instructions representative of a package build that includes a virtual environment. The machine-readable instructions when executed by a processor can cause the processor to simulate the virtual environment, receive a mode of operation for the virtual environment, identify a plant of a number of plants for industrial training, identify industrial equipment of the identified plant, provide the virtual environment with a model of the industrial equipment, and provide equipment description for the industrial equipment in the virtual environment.

Any combinations of the various embodiments and implementations disclosed herein can be used in a further embodiment, consistent with the disclosure. These and other aspects and features are better appreciated according to the following description of certain embodiments presented herein in accordance with the disclosure and the accompanying drawings and claims.

### BRIEF DESCRIPTION OF THE DRAWINGS

FIG. 1 is an example of a block diagram of an industrial training and creation system.

FIG. 2 is an example of a translation of an immersive environment in a real world into a virtual environment.

FIGS. 3-26 are examples of virtual environments according to the examples described herein.

FIG. 27 is an example computing environment that can be used to perform methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to a VR training tool for plant, industrial equipment and/or processes. The VR training tool provides a digital environment in which models of a plant, a plant equipment, and processes can be rendered. The VR training tool, in some implementations, is fully immersive and enables a user to simulate or experience industrial training as if the user is physically located on site (e.g., at a plant). In some instances, the VR training tool can be used on site and enable the user to walk the plant site virtually using the VR training tool and train on plant equipment and/or processes, but remain within a given area at the plant (e.g., a safe location).

The VR environment can simulate a real-world environment, such as an industrial environment, or provide a virtual learning environment that facilitates (e.g., enables) industrial training. The term “industrial training” and derivatives as used herein can include any type of industrial location, process, equipment, and/or any other related industrial training for supporting industrial methodologies and/or systems. While examples are described herein in which the VR training tool is adapted (e.g., programmed) for training one or more users on related fossil fuel technologies (e.g., oil, gas, coal, etc.), in other examples, the VR training tool can be adapted for training users on different types of industrial technologies (e.g., manufacturing, aerospace assembly, etc.).

The VR training tool can allow the user to learn features, characteristics, and/or operations using the virtual industrial representations in the virtual environment. In some examples, the VR training tool can allow the user to study internal and/or external workings of industrial equipment by allowing virtual representations of the industrial equipment in the virtual environment to be user interactive. In additional or alternative examples, the VR training tool can be configured to allow the user to study processes using a cut-away (x-ray) view feature, and a plant product process flow, and/or equipment auxiliaries. In some examples, the VR training tool can be configured to enable the user to visualize industrial equipment in miniature size. The VR training tool can also be configured, in some instances, to enable the user to view simultaneously in the virtual environment the virtual representation of the industrial equipment and an image of the industrial equipment in a real-world setting.

In some examples, the VR training tool can be configured to support or allow multiple users to join a similar or on-going session. Thus, the VR training tool can be used by multiple users simultaneously for plant training on a similar and/or different plant process, equipment, etc. By allowing multiple users to join-in or participate in plant training, it provides a digital classroom setting (or learning space) where users can learn in a more natural-like learning setting. In further or alternative examples, the VR training tool can be configured to support a third-party view. In the third-party view, one or more users (e.g., one or more trainees) can view a given user (e.g., a trainer, such as an instructor or teacher) as a spectator. In the third-party view, the given user can interact with virtual features in the virtual environment using a computer-generated interactive (CGI) asset for the given user, and the one or more users can view these interactions to learn about related industrial technologies and processes.

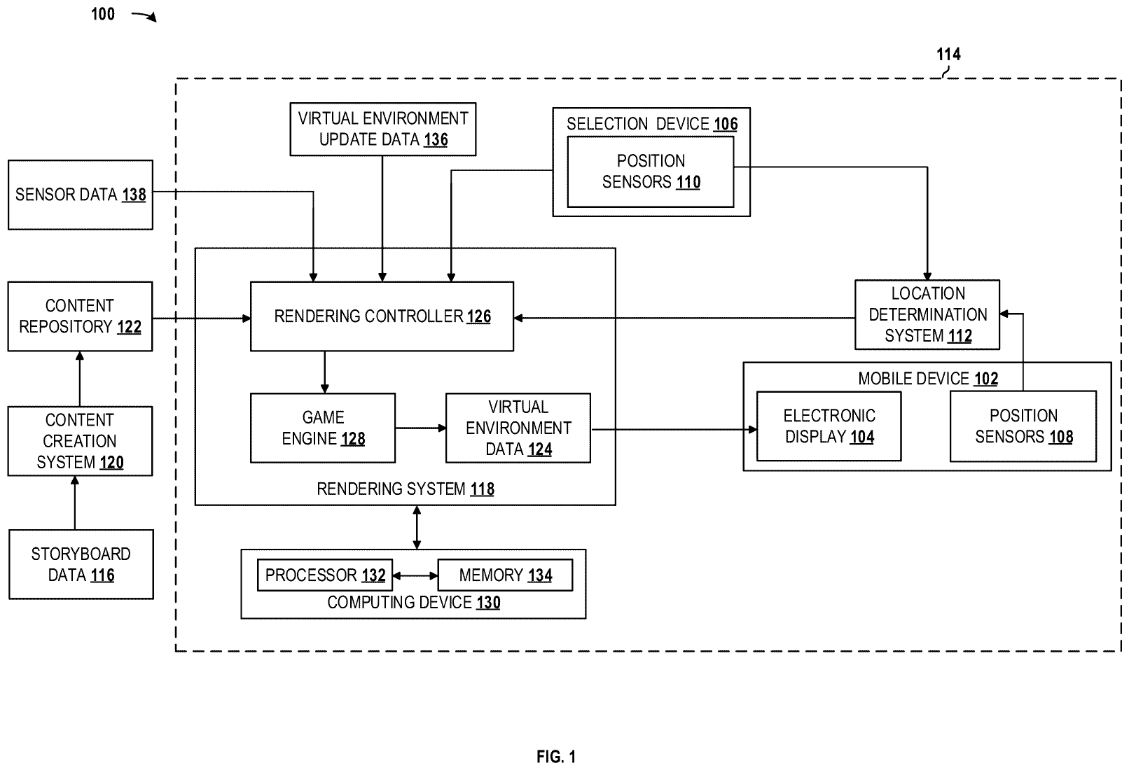

FIG. 1 is an example of a block diagram of an industrial training and creation system 100 (referred to herein as an “ITC” system) in which techniques can be performed according to the examples described herein. The ITC system 100 includes a mobile device 102 with an electronic display 104 that provides a view into a virtual environment, which can be used by a user (e.g., a trainee, a student, etc.) for learning and/or training. In some examples, the electronic display 104 can include a single electronic display or multiple electronic displays (e.g., a display for each eye of a user). Examples of the electronic display 104 include: a liquid crystal display (LCD), an organic light emitting diode (OLED) display, an active-matrix organic light-emitting diode display (AMOLED), some other display, or some combination thereof. In some instances, the electronic display is a touchscreen interface or display.

In some instances, the mobile device 102 can correspond to a VR headset, augmented reality (AR) glasses, a smart phone, a tablet, or any other suitable mobile device. While in examples herein the mobile device 102 is shown and described, in other examples, a computer, such as a stationary computer can be used instead of the mobile device 102 for providing the view into the virtual environment. In some examples, the ITC system 100 includes a selection device 106. The selection device 106, in some instances, can correspond to any device that enables the user to interact or use the virtual environment. While a respective selection device is shown in the example of FIG. 1, in other examples, a number of selection devices can be used. The selection device 106 can be used to interact with content in the virtual environment. In some examples, the mobile device 102 and the selection device 106 can be combined into a single device, such as a smartphone, tablet, portable computer, or any other suitable device. Although not shown in the example of FIG. 1, in some instances, the mobile device 102 and the selection device 106 can be distributed amongst one or more users. In some instances, the selection device 106 corresponds to a joystick or a gaming controller.

In some examples, the mobile device 102 and/or the selection device 106 can include position sensors 108 and 110, respectively. The position sensors 108 and 110 can be an integrated part of these devices, and may include GPS receivers, radio-frequency transmitters/receivers, accelerometers, gyroscopes, tilt sensors, compasses, and so forth. Some devices may also include visual fiducials that can be identified by a plurality of cameras. In some examples, a plurality of cameras are part of a location determination system 112. The location determination system 112 can receive inputs from the position sensors 108 and 110 to determine a position and/or orientation of the mobile device 102 and/or selection device 106. In some examples, referred to as a “given example,” the location determination system 112 may also determine a position and/or orientation of other objects associated with the user. In the given example, the location determination system 112 can determine the position and/or orientation of a user's head, a user's torso, or a portion of clothing worn by the user. The location determination system 112 need not receive any inputs from the position sensors 108 and 110 in the given example. Instead, in the given example, the location determination system 112 can determine the location of the mobile device 102 and/or the selection device 106 using video analysis, laser range finders, microwave radiation, or any other technology that admits energy from the location determination system 112 that is reflected back by the user, such as infrared sensors or room scanning sensors (e.g., Microsoft Kinect®). In some examples, the location determination system 112 can include a motion capture system with a plurality of video cameras, and may follow the performance of a user using one or more physical markers, wireless transmitters, depth information for the selection device 106, GPS information for the selection device 106, location information received from the selection device 106, and so forth. In some embodiments, the location determination system 112 can be combined with a rendering system 118, as described herein. The mobile device 102, the selection device 106, and the rendering system 118 can collectively be referred to in some instances as a VR training tool 114. In some implementations, the VR training tool 114 includes the location determination system 112.

In some examples, the ITC system 100 includes a content creation system 120. The contention creation system 120 can include one or more computers capable of editing and/or generating detailed (e.g., highly detailed) and/or high-fidelity virtual environments, including a two-dimensional (2-D) or a three-dimensional (3-D) virtual environment. For example, the content creation system 120 can be used to create the virtual environment that is used herein for industrial training. The virtual environment can be one of an industrial plant, or a number of industrial plants. The virtual environment may also include one or more objects forming or part of an industrial plant. Thus, the virtual environment can include industrial equipment (e.g., pipes, machinery, tools, etc.).

In some examples, the virtual environment includes objects such as digital kiosks, as described herein, that the user can interact with to engage or interface with the virtual environment to facilitate learning and/or training. In further or other examples, the virtual environment includes one or more objects such as characters, clouds, sun, moon, bridges, waterways, roads, a plant process layout, and other types of industrial objects. The content creation system 120 can be configured to provide or deposit content objects into a content repository 122.

The content repository 122 can include libraries or databases of content objects that can be used to construct the virtual environment. For example, the content repository 122 can include 3-D environment content that includes scenery, environments, objects, and so forth. Additionally, the content repository 122 can include a library of digital content that includes video clips, images (e.g., of plant processes, equipment, a plant, etc.) animations, movies, sound recordings (e.g., audio narrations), and other predetermined sequences of sound and/or motion that may be included in the virtual environment. In some examples, the content repository 122 can include a library of computer-generated imagery (CGI) characters, which once selected or assigned to the user can be rendered in the virtual environment for that user. For example, a CGI character can be rendered and the user can use the selection device 106 to move the CGI character through the virtual environment (e.g., to study how equipment and/or processes therein work/function).

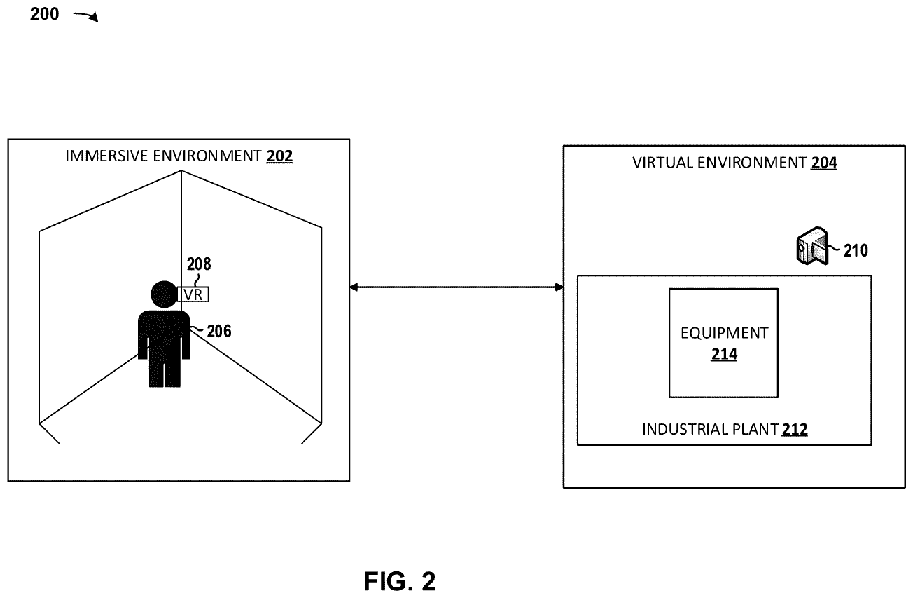

A rendering system 118 can be configured to provide an image frame representative of the virtual environment for rendering on the electronic display 104. The rendering system 118, as described herein, can provide virtual environment data 124 that includes images frame of the virtual environment. In some examples, the rendering system 118 can render the image frames from a perspective of a virtual camera corresponding to a point of view in an immersive environment (e.g., an immersive environment 202, as shown in FIG. 2.) As shown in FIG. 1, the virtual environment data 124 can be provided (e.g., transmitted, over a wired and/or wireless link) to the electronic display 104 and rendered thereon to provide one or more views into the virtual environment.

In some examples, the rendering system 118 can include one or more computers capable of rendering the virtual environment in real-time and/or at interactive frame rates (e.g., greater than 15 frames per second (FPS)). Virtual objects or elements from the content repository 122 may be considered as digital assets that can be received by a rendering controller 126 for a game engine 128 of the rendering system 118. In some examples, the rendering controller 126 can be implemented as a plug-in. For example, the game engine 128 can be a commercially available gaming engine, such as Unreal Engine 4®, Unreal Engine 5®, or Unity Engine®. The game engine 128 can be configured to run the content and instructions provided by the rendering controller 126. The rendering controller 126 allows the user to manipulate and/or interact with objects (e.g., a kiosk, equipment, menu items, buttons, etc.) in the virtual environment using the selection device 106.

In some embodiments, the rendering controller 126 and the game engine 128 can operate in real time on a computing device 130, as shown in FIG. 1. However, in some examples, a package build can be created (e.g., using the game engine 128) that includes the virtual environment and corresponding content from the content repository 122. This allows the package build to be distributed to users by download or physical digital media to use on their own home immersive environment, such as a home virtual-reality system, home theater, or on their own mobile computing device. The package build need not require an instance of the rendering controller 126 and the game engine 128 in order to run on a user device. Thus, the package build can be distributed independent of the rendering controller 126 and the game engine 128.

After rendering the virtual environment (e.g., in some instances in real-time), the mobile device 102 can simultaneously present the image frames generated and transmitted from the rendering system 118 as the virtual environment data 124 on the electronic display 104. The image frames can be presented to a user at or above a particular frame rate (e.g., 15 FPS, 30 FPS, 60 FPS, 120 FPS, etc.). In one example, the mobile device 102 can be a pair of VR goggles or a similar immersive device. The selection device 106 can be a pair of handheld controllers. Users controlling each of the mobile device 102 and/or selection device 106 can move around in the virtual environment, which can move the virtual camera therein to change a perspective or point of view in the virtual environment.

For instance, the virtual camera can be controlled by physically changing the position and/or orientation of the mobile device 102. For example, a user may move forward a given number of feet from a current location while wearing the mobile device 102 on a user's head. The mobile device 102 can detect such movement based on one or more sensors of the mobile device 102 (e.g., an accelerometer, gyroscope, GPS, depth sensor, camera, wireless radio, etc.). The information regarding the detected movement can be transmitted to the rendering system 118 (or the location determination system 112 (e.g., a motion capture system)), which may in response shift the virtual camera and transmit updated image frames (as the virtual environment data 124) to the mobile device 102 with the virtual camera having moved the given number of feet in the virtual environment. Thus, this real-time feedback provided by the mobile device 102 and/or the selection device 106 allows for interactive industrial learning. The examples herein provide a VR experience for users in their homes, in a classroom setting, on site, and so forth, that enables the users to learn how industrial plants, processes, and/or equipment operator and/or function.

In some examples, the content creation system 120 can receive storyboard data 116. The storyboard data 116 can provide a roadmap for creation of the virtual environment. The storyboard data 116 can include still images corresponding to different aspects of the roadmap. The roadmap can be a visual or graphical representation of the virtual environment in a storytelling format. The roadmap can specify how a training or learning process flows and how the user can interact and learn in the virtual environment. Thus, the roadmap can specify or identify plants, plant layouts, equipment, processes, how a user learns how the equipment and/or processes function/operate, equipment relationships, and how a plant functions/operates. The storyboard data 116 can be provided to the content creation system 120 to provide the content repository 122 and thus rendering of the virtual environment.

In some examples, the rendering system 118 can be implemented using one or more modules, shown in block form in the drawings. The one or more modules can be in software or hardware form, or a combination thereof. In some examples, the rendering system 118 can be implemented as machine readable instructions for execution on the computing device 130, as shown in FIG. 1. The computing device 130 can include any computing device, for example, a desktop computer, a server, a controller, a gaming system, a console, a blade, a mobile phone, a tablet, a laptop, a personal digital assistant (PDA), a tablet, and the like. The computing device 130 can include a processor 132 and a memory 134. By way of example, the memory 134 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 132 could be implemented, for example, as one or more processor cores. The memory 134 can store machine-readable instructions (e.g., which can include the rendering controller 126 and the game engine 128) that can be retrieved and executed by the processor 132. Each of the processor 132 and the memory 134 can be implemented on a similar or a different computing platform. The computing platform could be implemented in a computing cloud. In such a situation, features of the computing platform could be representative of a single instance of hardware or multiple instances of hardware executing across multiple of instances (e.g., distributed) of hardware (e.g., computers, routers, memory, processors, or a combination thereof). Alternatively, the computing platform could be implemented on a single dedicated server or workstation.

In some examples, the rendering controller 126 can receive virtual environment update data 136 that includes new industrial equipment, identifies existing industrial equipment that is to be removed from the virtual environment, and/or changes to an industrial process (e.g., a plant process map, as described herein). The virtual environment update data 136 can be provided as a java script (.js) setting file. The rendering controller 126 can update the virtual environment and thus industrial plant, plant process, and/or industrial equipment therein based on the virtual environment update data 136. The rendering controller 126 can update the virtual environment (e.g., in some instances cooperating with the game engine 128, or instructing the game engine 128) without changing code or compiling new code changes for the industrial plant, plant process, and/or industrial equipment in the virtual environment.

In some examples, the rendering controller 126 can receive sensor data 138 from one or more sensors and/or systems used in an industrial plant. The one or more sensors and/or systems can monitor an industrial process and/or equipment used in the industrial process. The sensor data 138 can characterize or provide measurements for one or more process parameters, other industrial parameter data for the industrial process, and/or industrial equipment (or sensors) used in the industrial process. The rendering controller 126 can update (or cooperate with the game engine 128 to update, or instruct the game engine 128 to update) the virtual industrial environment and thus the industrial process (e.g., a quantity of a compound mixed, etc.), and/or the industrial equipment used in the process (e.g., a setting of the industrial equipment, for example, a temperature, a flow, a pressure, a speed, and/or other process variables) By incorporating process parameters into the virtual industrial environment allows the user learn about the process parameters as these process parameters change, and provides the user with a more real-life immersive environment for learning.

FIG. 2 illustrates an example of a translation of an immersive environment 202 in a real world into a virtual environment 204 provided by the rendering system 118, as shown in FIG. 1. Thus, reference can be made to the example of FIG. 1 in the example of FIG. 2. The virtual environment 204 can be rendered on the mobile device 102 based on the virtual environment data 124, as shown in FIG. 1. In the example of FIG. 2, a user 206 can wear a pair of VR goggles 208 corresponding to the mobile device 102. In the virtual environment 204, a virtual camera 210 can be generated at a location corresponding to an orientation and location of a head of the user 206 in the immersive environment 202. As the head of the user 206 moves in the immersive environment 202, the virtual camera 210 can move in a corresponding fashion in the virtual environment 204. The virtual environment 300 can include a virtual representation (e.g., one or more models) of an industrial plant 212 and/or industrial plant equipment 214. The user 206 can interact with the virtual environment 204 to learn about the industrial plant 212 and/or the equipment 214, which is represented in digital form in the virtual environment 204. For example, visual elements (e.g., a menu, a kiosk, etc.) can be rendered in the virtual environment 204 that facilitates industrial plant and/or equipment learning.

In some examples, the virtual camera 210 corresponds to a point of view in the immersive environment 202, which can be translated to a particular point of view in the virtual environment 204. Thus, as the head of the user 206 moves in the immersive environment 202 an aspect of the virtual camera 210 changes to provide a different perspective into the virtual environment 204. As such, the virtual camera 210 provides an access viewpoint into the virtual environment 204, which can be referred to herein as a “first-person view”. In some examples, the virtual camera 210 can be configured to provide a “god's eye” or spectator view into the virtual environment 204, or a portion thereof, for example, during a third-party view. This allows a user (e.g., a trainee) to observe a CGI asset representative of another user (e.g., a trainer, such as a teacher) rendered in the virtual environment 204 as the other user interacts with the industrial plant 212 and/or industrial plant equipment 214. Thus, the CGI asset observed in the third-party view enables the user 206 to learn from the interactions of the other user with the industrial plant 212 and/or industrial plant equipment 214.

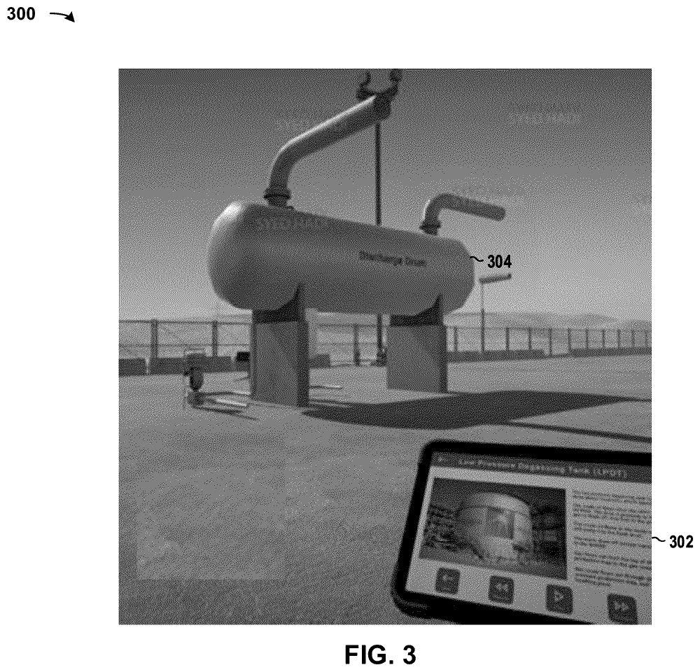

FIG. 3 illustrates a first-person view within a virtual environment 300, which can correspond to, in some instances, to the virtual environment 204, as shown in FIG. 2. Thus, reference can be made to the example of FIGS. 1-2 in the example of FIG. 3. For example, as shown in FIG. 3, the virtual environment 204 can include a kiosk 302 (e.g., a virtual model) with which the user can interact via the selection device 106 to learn about industrial equipment 304, which is rendered as a virtual model therein. For example, the kiosk 302 can be used by the user to become familiar with the industrial equipment 304. Thus, the user can learn about internal workings of the industrial equipment 304 using a cut-away feature, as described herein.

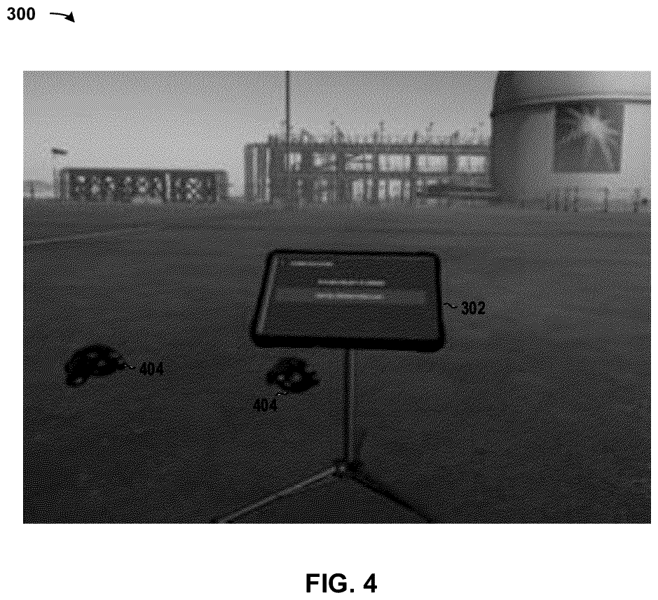

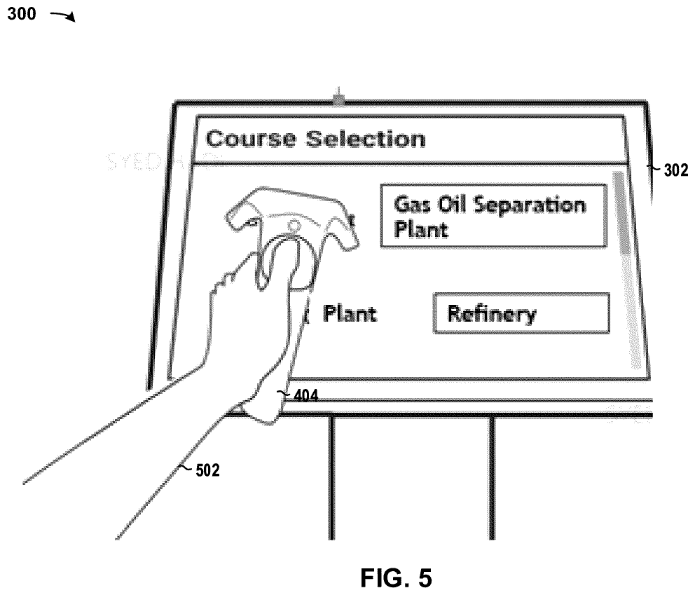

FIG. 4 illustrates another first-person view within the virtual environment 300. In the example of FIG. 4, the virtual environment 300 includes the kiosk 302 with virtual selection devices 404 representative of one or more selection devices, such as the selection device 106, as shown in FIG. 1. The user can employ the one or more selection devices to cause the virtual selection devices 404 to interact with the kiosk 302 to select a training course, for example, as shown in FIG. 5. FIG. 5 is an example of the kiosk 302 with a course selection graphical user interface (GUI). In the example of FIG. 5, at least one selection device for the selection devices 404 can be used to select a training course. The training course, as shown on the kiosk 302 in FIG. 5, includes a gas oil separation plant training course for a gas oil separation plant, and a refinery training course for a refinery plant. A CGI asset 502 representative of the user can be rendered in some instances in the virtual environment 300, as shown in FIG. 5, which can be referred to as a user CGI asset, or in some instances, student CGI asset. The user can interact with the kiosk 302 to select a type of plant that the user wants to learn about and associated equipment in the selected plant.

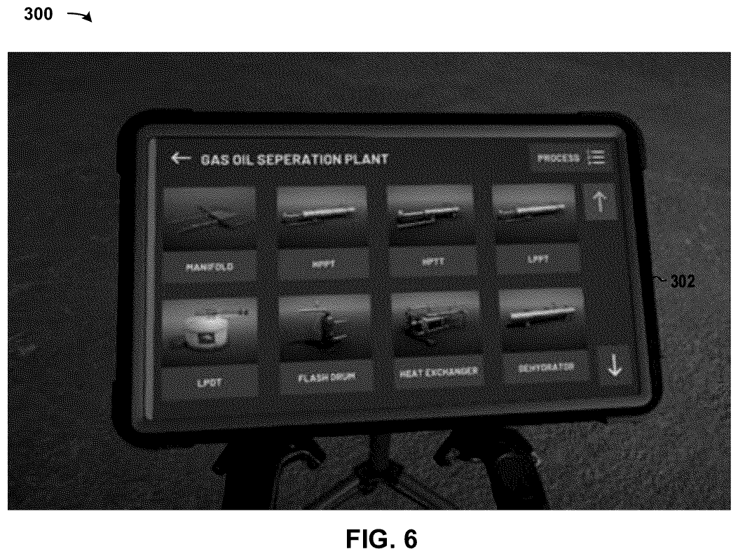

For example, FIG. 6 illustrates a first person view within the virtual environment 300 in which the kiosk 302 includes a list of the associated equipment for the selected plant. In the example of FIG. 6, the selected plant is the gas oil separation plant. For example, the user can scroll through an equipment selection GUI rendered on the kiosk 302 to select a corresponding model or equipment that the user would like to learn about, for example, using the selection device 106. Because there are numerous equipment that the user can learn about, the user can use the selection device 106 to scroll through an equipment list by interacting with one or more arrows of the equipment selection GUI, as shown in FIG. 6.

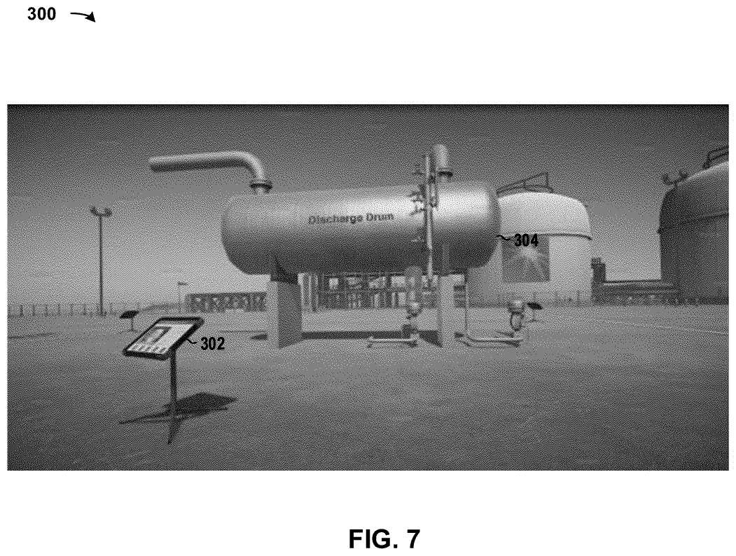

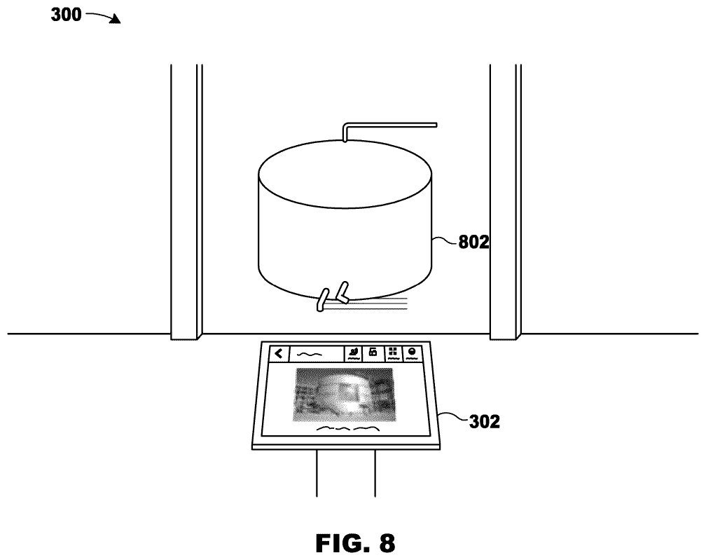

In some examples, the user can select equipment from the equipment list and cause the virtual environment 300 to be updated with the selected equipment 304 or vessel model. The selected equipment can “pop” into the virtual environment, as shown in FIG. 7. A first person perspective can change in the virtual environment 300 to bring selected equipment 304 and the kiosk 302 into a single field of view. The kiosk 302 can be updated to include relevant information and an actual field image of the selected equipment 304. The user can use the selection device 106 to interact with the kiosk 302 to learn about the selected equipment 304 and to compare the equipment 304 to a real-world image of the selected equipment 304. In some examples, the user can select equipment and the virtual environment 300 can be updated to include a vessel real size equivalent model 802 that can “pop” into virtual environment 300 and the kiosk 302 can be updated to include relevant information and an image of the equipment, as shown in FIG. 8. The virtual environment 300 can be updated to only show the vessel real size equivalent equipment model 802 and the kiosk 302 while obfuscating, occluding, hiding (e.g., cutting away) a surrounding of the virtual environment 300, as shown in FIG. 8.

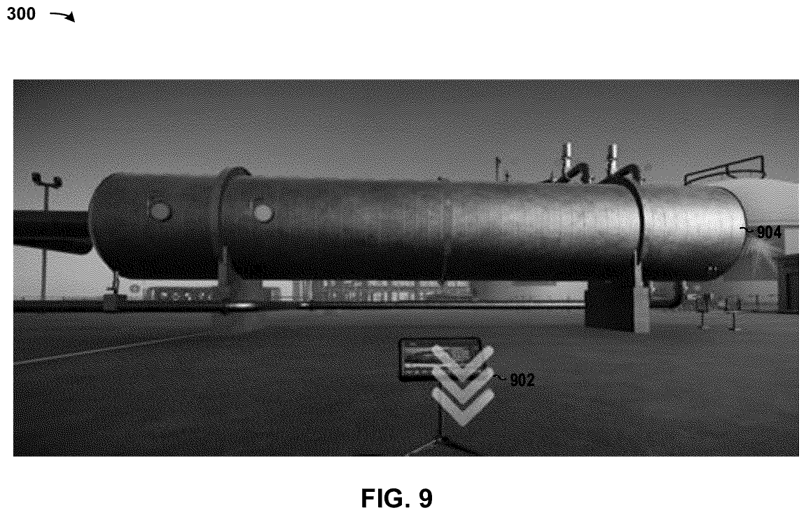

In some examples, the virtual environment 300 can be updated to include an icon 902 (e.g., in the example of FIG. 9 a triple arrow pointing down) identifying a virtual location in the virtual environment 300. The user can navigate to the virtual location using the selection device 106 and interact with the kiosk 302 to learn about equipment 904 in the virtual environment 300. Thus, in some instances, the icon 902 can identify a location to which the user can navigate to initiate industrial learning. In some examples, industrial equipment in the virtual environment 300 can be associated with a respective kiosk and thus the user can navigate through the virtual environment 300 (e.g., of an industrial plant) and interact with corresponding kiosks to learn about associated industrial equipment and/or processes.

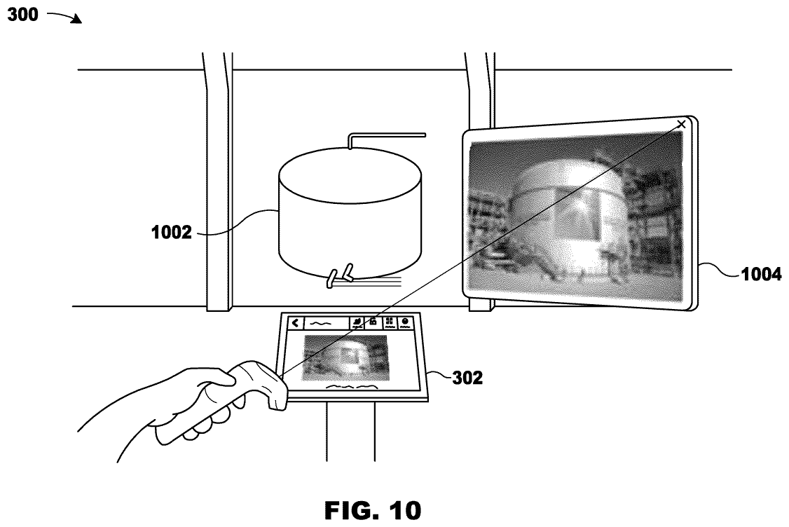

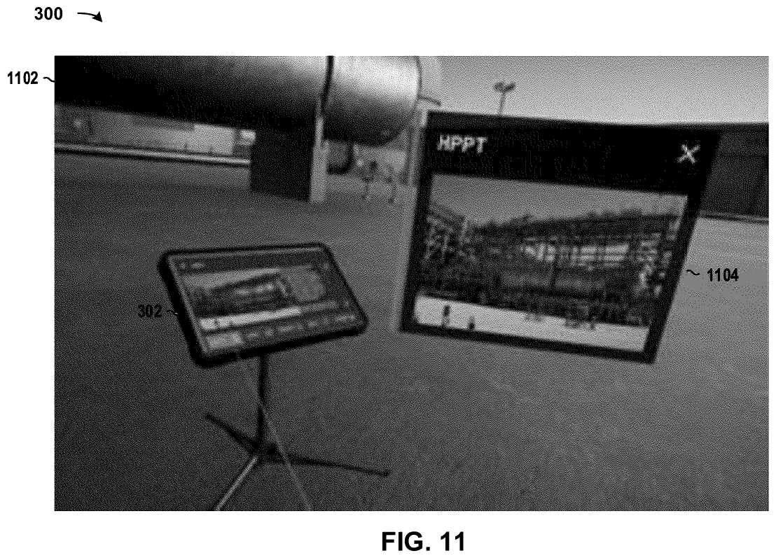

In some examples, the virtual environment 300 can be rendered to only show selected equipment 1002 and the kiosk 302 while obfuscating, occluding, hiding (e.g., cutting away) a surrounding of the virtual environment 300, as shown in FIG. 10. In some examples, the kiosk 302 includes a pop-out function GUI element that the user can activate using the selection device 106 to cause a photo to “pop out” as a pop-out GUI 1004. The photo can be an actual picture of the equipment 1002 and enables the user to see the virtual rendering of the equipment in a side by side comparison to a real-world picture of the equipment. This allows the user to familiarize themselves with a real-life depiction of the equipment 1002. The user can interface with an exit GUI element of the pop-out GUI 1004 to close the pop-out GUI 1004 using the selection device 106, as shown in FIG. 10. FIG. 11 is an example of the virtual environment 300 that includes equipment 1102 in which the surrounding of the virtual environment 300 has not been removed (e.g., in contrast to FIG. 10). The user can employ the selection device 106 to interact with the kiosk 302 to provide a pop-out GUI 1104 that includes or shows a portion of the industrial plant in which the equipment 1102 is used.

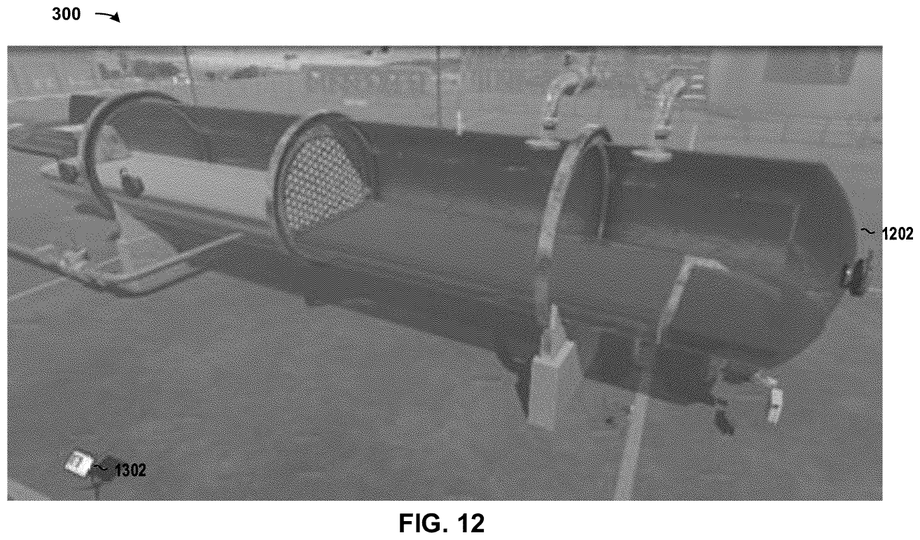

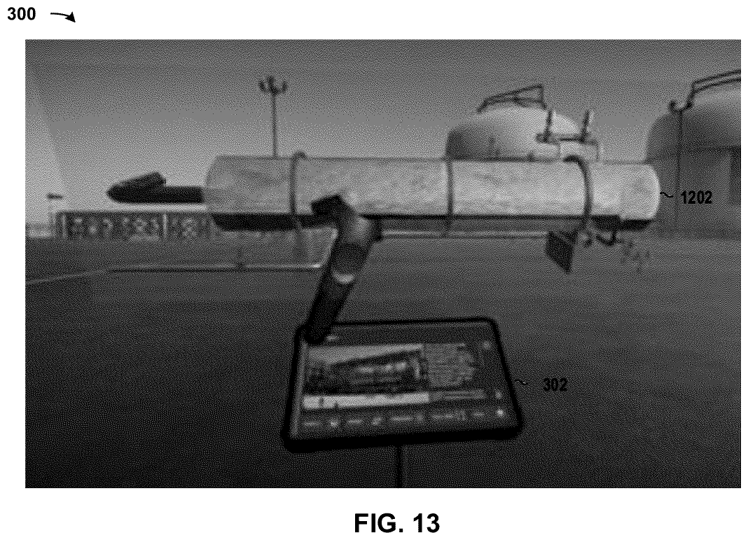

FIG. 12 is an example of the virtual environment 300 with equipment 1202 which has been cut-away to show internal workings therein. For example, the kiosk 302 in the virtual environment 300 can include a cut-away interactive graphical element that can be activated by using the selection device 106 to activate a cut-away animation. The user can deactivate the cut-away animation to turn off the cut-away view of the equipment 1202. FIG. 13 is an example of the virtual environment 300 with the equipment 1202 at a different perspective that includes the kiosk 302 at a different granularity level (e.g., level of detail).

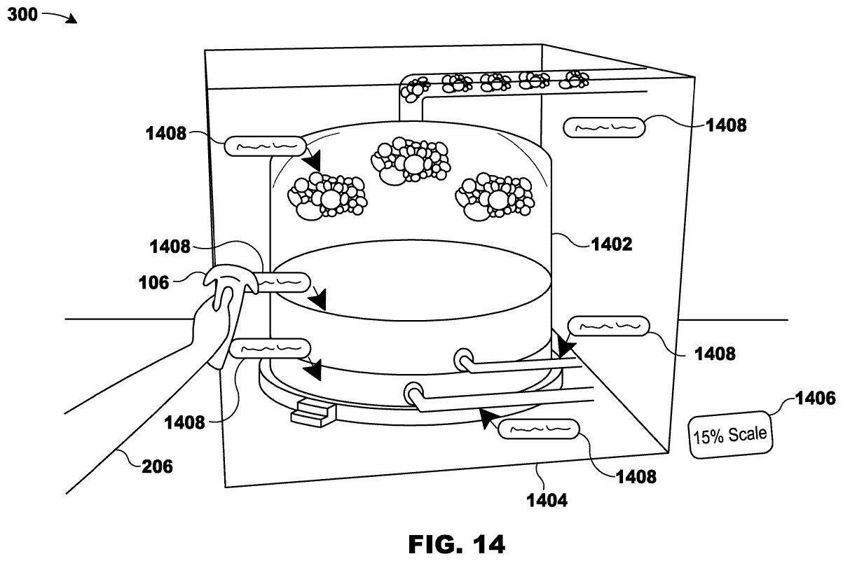

FIG. 14 is an example of the virtual environment 300 rendered to only show selected equipment 1402 while obfuscating, occluding, hiding (e.g., cutting away) a surrounding of the virtual environment 300. In the example of FIG. 14, labels 1408 can be provided for different features of the equipment 1402 to enable the user to learn about different equipment features. In some instances, the equipment 1402 is rendered using a scaling interactive graphical element 1404, which one or more corners therein can be interacted with (e.g., by dragging and dropping) to scale a size of the equipment 1402 in the virtual environment 300. In the example of FIG. 14, the selected equipment 1402 is scaled to 15%, as shown at 1406. For example, the selection device 106, which is shown as overlaying the virtual environment 300, can be used by the user 206 to scale the equipment 1402. The user 206 can see an internal workflow of the equipment 1402 by enlarging the equipment 1402.

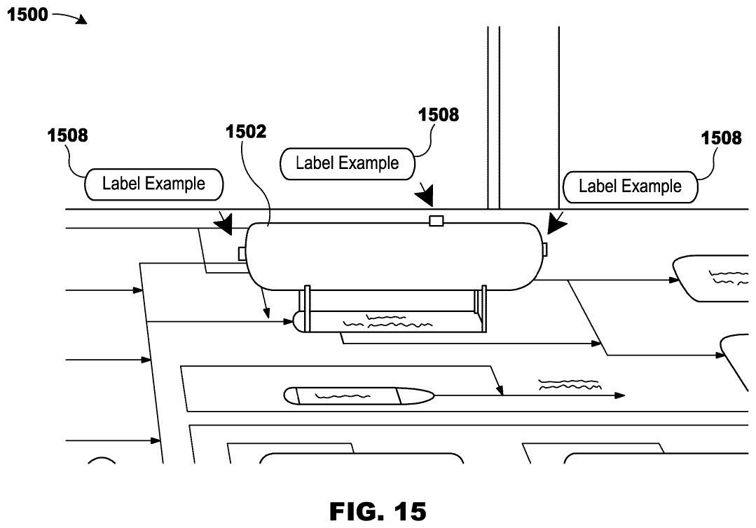

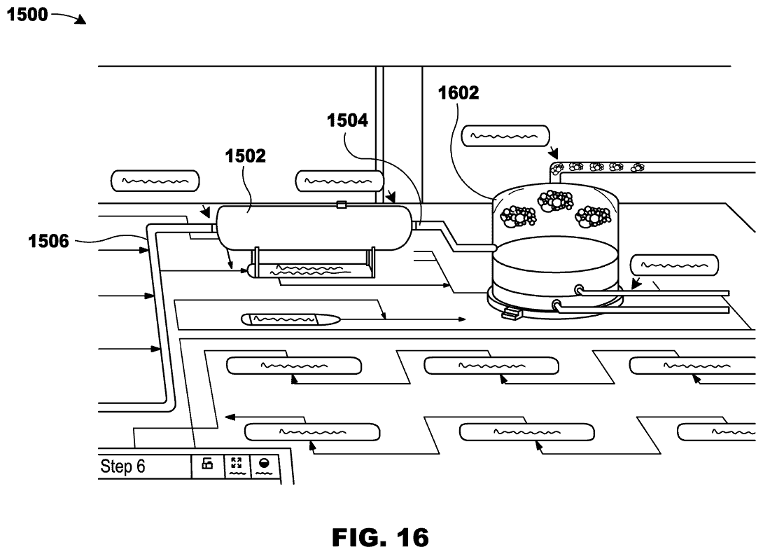

In some examples, the virtual environment 300 can include a process flow GUI element on the kiosk 302, which the user can activate to see a process flow in which selected equipment (e.g., the equipment 1202, as shown in FIG. 13) is being used. The process flow GUI can be associated with one or more process flows for a given plant. FIG. 15 is an example of a process flow 1500. The process flow 1500 can allow a user to learn about a particular plant process, and further how the selected equipment operates in the plant process. In some examples, at least one or more types of equipment that are part of the process flow can be user-selected by the user 206 by the selection device 106. For example, if the user wants to learn about equipment 1502 in the process flow, the user 206 can use the selection device 106 to identify equipment 1502, which will elevate or raise the identified equipment from the process flow 1500 and present the kiosk 302 with relevant equipment information the identified equipment 1502. In the example of FIG. 15, labels 1508 can be provided for different features/auxiliaries of the equipment 1502 to enable the user to learn about different equipment features. In some examples, relevant flow paths 1504-1506 of the process flow 1500 can also be raised that are related (e.g., associated with) the identified equipment 1502, as shown in the example of FIG. 16.

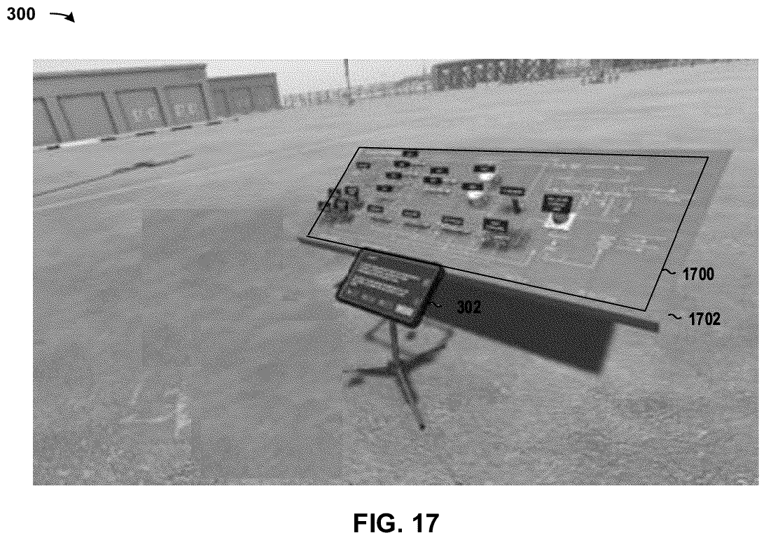

FIG. 16 is an example of the process flow 1500 that includes equipment 1602 elevated and raised in a same or similar manner as the equipment 1502. By elevating neighboring or related equipment that are part of a similar process flow enables the user 206 to study how these equipment interact and are interconnected. In some instances, the kiosk 302 can provide relevant information relating to equipment interaction and connection. In some examples, a process flow can be rendered as part of the virtual environment 300. For example, a process flow 1700 can be rendered on a process flow graphical element 1702, as shown in FIG. 17. FIG. 17 is an example of the virtual environment 300 with the process flow 1700 and the kiosk 302 to which the user can navigate using the selection device 106.

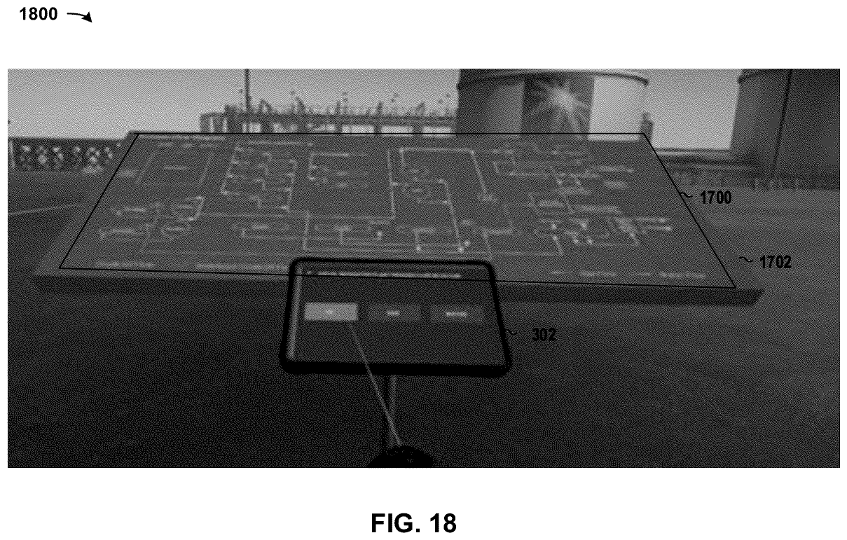

In some instances, in order to follow a process flow, such as the process flow 1700 for a product, the user can use the kiosk 302 to select or identify a product that the user would like to track through a process flow. FIG. 18 is an example of the virtual environment 300 with the process flow 1700. When following a flow, the information relating to the steps will appear on the kiosk 302, where a user can go to the next step, go to the previous step, and hear a narration (e.g., describing the process flow and/or equipment for the product flow). At each stage, the equipment that is being highlighted in the virtual environment 300 can be raised from neighboring graphical elements in the process flow 1700, with previous models (e.g., equipment) staying up, to show the flow of a selected product. Thus, for all the stages, of a process flow, equipment that is part of the process flow can be raised. The user can activate a cut-away graphical element (e.g., on the kiosk 302) while following the product flow to access an internal view for selected equipment.

In some instances, the virtual environment 300 supports teleporting around so that the user is not required to walk around in the virtual environment 300 to reach a point of interest therein (e.g., equipment). Teleporting around the virtual environment 300 can be done by the user pressing the selection device 106 to aim at a location in the virtual environment 300, and releasing to teleport to the location. In some instances, plant equipment can be generated in the virtual environment 300, such as described herein, with labeled features or components that can have interactive highlight points, which can be activated by the user at a distance by pointing and pressing a trigger or by touching the highlight point using the selection device 106. In some examples, equipment within the virtual environment can be miniaturized. For example, the user can interact with a scale in size graphical element (e.g., on the kiosk 302) to change a size of the equipment (e.g., as shown in FIG. 14 in which the equipment 1402 is scaled to 15% of an original scale size). To go back, the user can interact with a full size graphical element (e.g., on the kiosk 302) to increase a scale size of the equipment. Once the equipment has been increased to a given scale size (e.g., 100%), the equipment can be in a fixed position and not movable in the virtual environment 300. As a full scale or miniature size model for the equipment is displayed in the virtual environment 300, equipment auxiliaries can be highlighted using a graphical element.

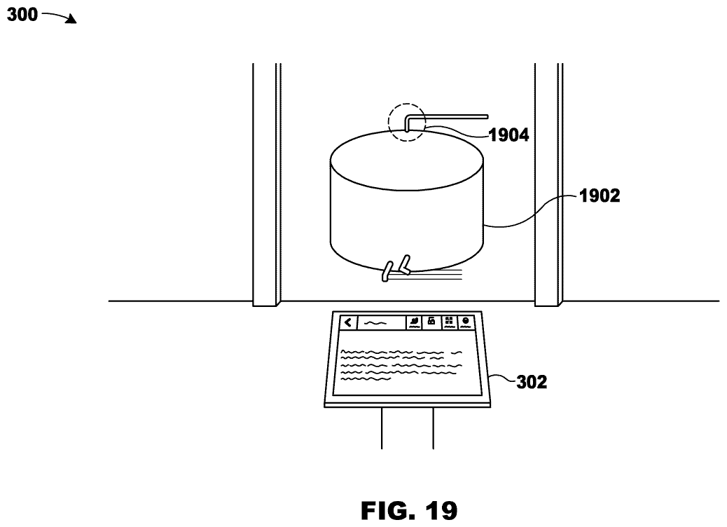

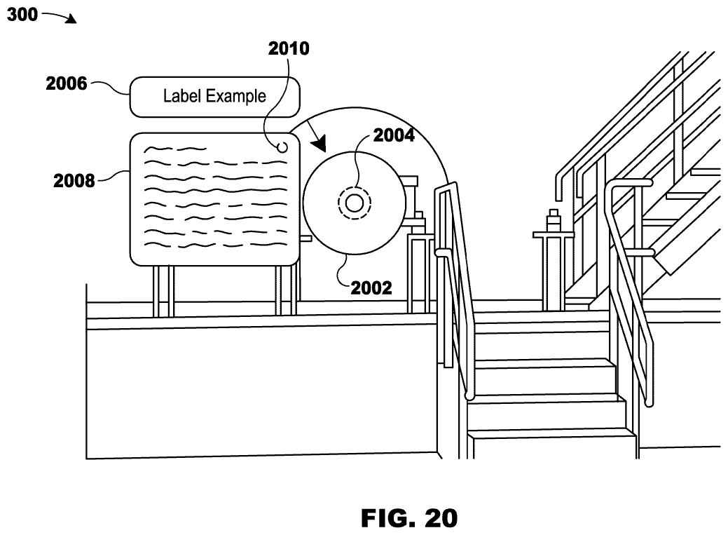

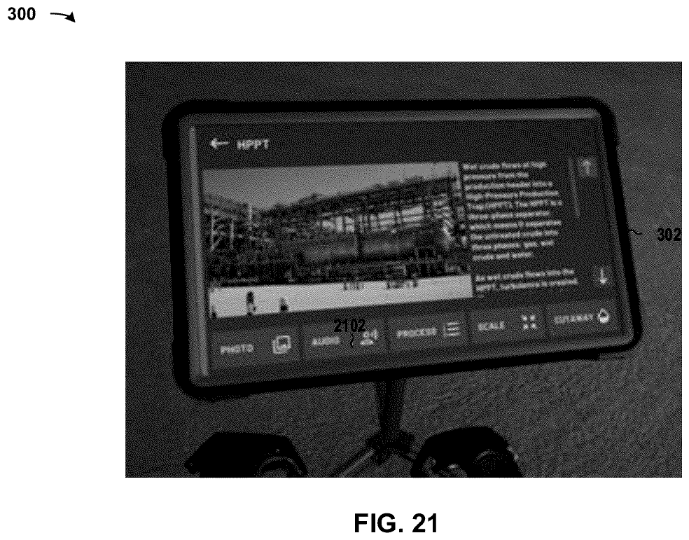

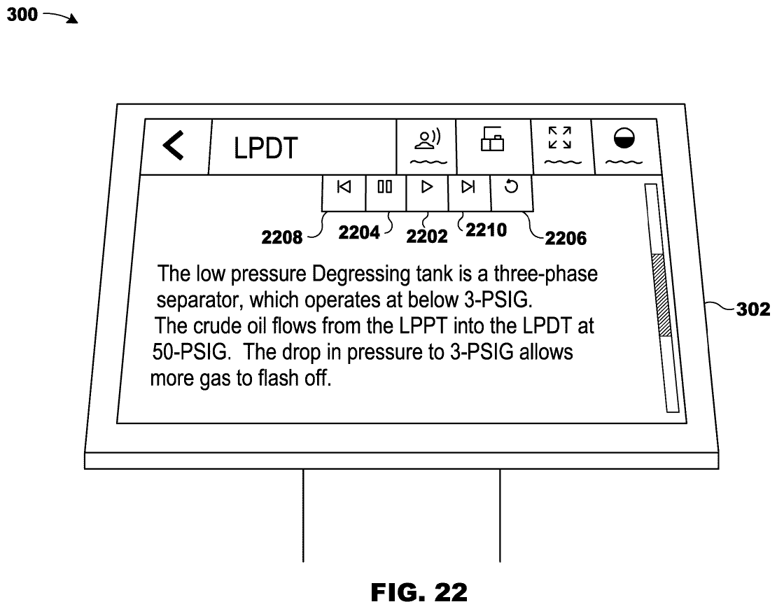

FIGS. 19-20 illustrate examples in which equipment auxiliaries for equipment 1902 and 2002 are highlighted using a graphical element 1904 and 2004, respectively. A label 2006 (identifying an equipment auxiliary) and a detail graphical element 2008 can be displayed with auxiliary information relating to a corresponding auxiliary of the equipment 2002 in the virtual environment 300. The detail graphical element 2008 can include an audio graphical element 2010 that the user can activate for narration of the auxiliary information. Equipment in the virtual environment 300 can be associated with an audio graphical element for narration of relevant equipment information (e.g., how to use the equipment, etc.). FIG. 21 is an example of the virtual environment 300 with the kiosk 302 rendered with an audio graphical element 2102 for the narration of equipment information. For example, the user can activate the audio graphical element 2102, which can update the kiosk 302 to render a GUI with audio graphical elements 2202-2210, as shown in FIG. 22. The audio graphical elements 2202-2210 can correspond to narration controls. Whenever narration is playing, audio controls can be accessible by pressing an audio graphical element (e.g., on the kiosk 302), which can expand to show options of “Play”, “Pause”, “Replay”, “Rewind”, and “Fast Forward”. As the narration plays, a specific part that the narration is explaining can be visually highlighted on the equipment in the virtual environment 300 for the user 206.

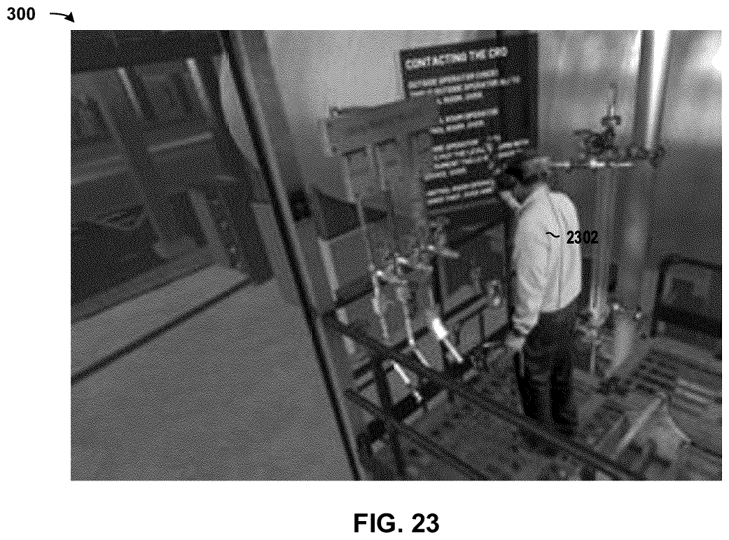

FIG. 23 is an example of the virtual environment 300 in a spectator mode. In the spectator mode, the user can follow a CGI asset 2302 for a teacher to learn and see how the teacher interacts with equipment and/or other operations of a plant rendered in the virtual environment 300. By providing the spectator mode, students can watch a teacher as if the students are watching the teacher through a video feed of the plant in the real world.

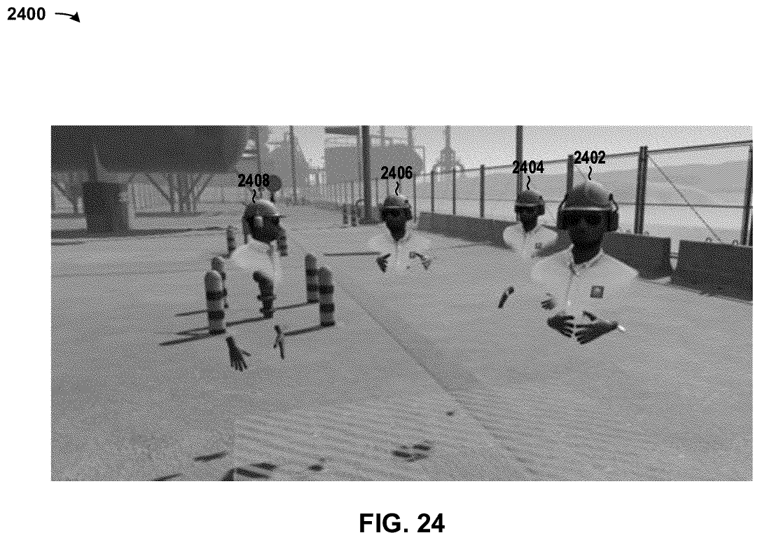

In some examples, the user 206 can join a session of the virtual environment as a single user or as a part of a multi user session, in which a number of different users can learn simultaneously. FIG. 24 is an example of a virtual environment 2400 in which multiple CGI assets 2402-2408 for different users are present. In a multi-user mode, the users can see cut-away or partial avatars (CGI assets 2402-2408) of other users that are in this session as well. This allows the simulation to be used as a collaborative teaching tool by a class teacher. For example, at a session login, a user can decide whether the user wants to join the session as a single user where the single user simulation is loaded or to join as part of a class in multi user mode.

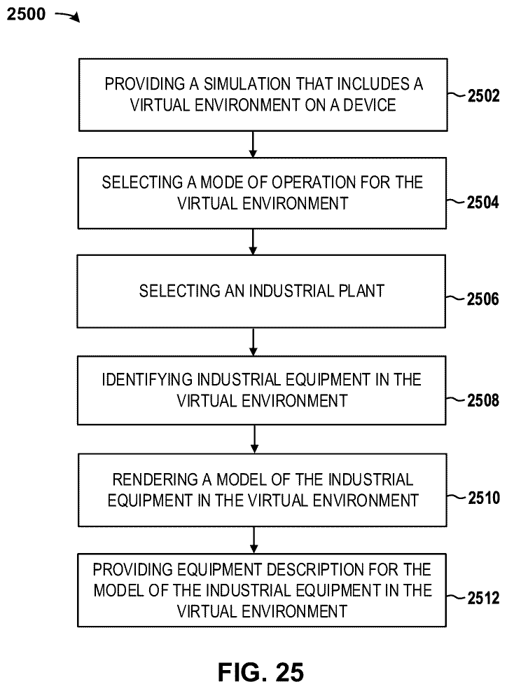

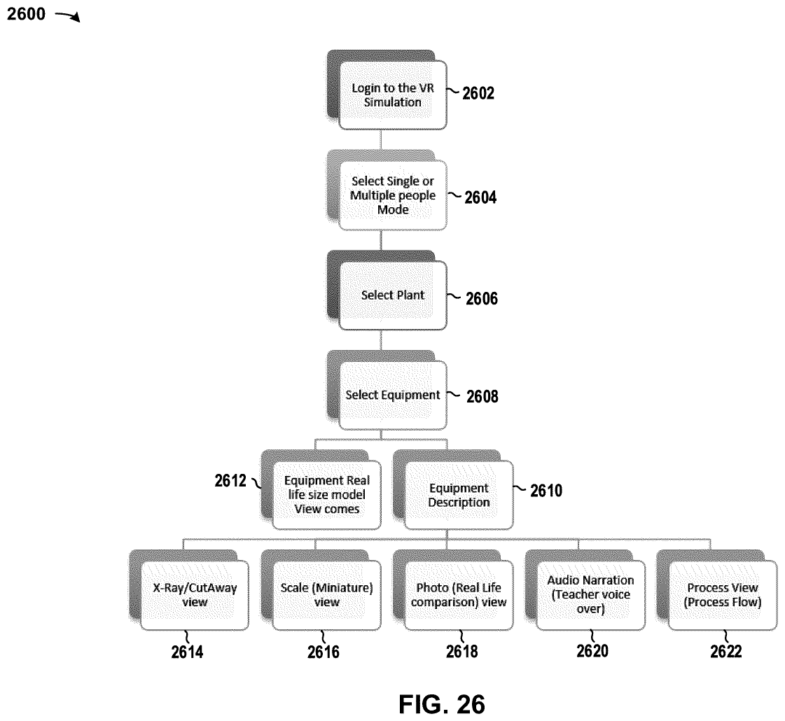

In view of the foregoing structural and functional features described above, example methods will be better appreciated with reference to FIGS. 25-26. While, for purposes of simplicity of explanation, the example methods of FIGS. 25-26 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 25 is an example of a method 2500 for industrial virtual training. The method 2500 can be implemented by the VR training tool 114, as shown in FIG. 1. Thus, reference can be made to the example of FIGS. 1-2 in the example of FIG. 25. The method 2500 can begin at 2502 by providing, on a device (e.g., the mobile device 102, as shown in FIG. 1), a simulation that includes a virtual environment (e.g., the virtual environment 204, as shown in FIG. 2). At 2504, a mode of operation for the virtual environment can be selected in response to a selection device (e.g., the selection device 106, as shown in FIG. 1). At 2506, an industrial plant can be selected in response to the selection device. At 2508, industrial equipment in the virtual environment can be identified in response to the selection device. At 2510, a model of the industrial equipment in the virtual environment can be rendered. At 2512, equipment description for the model of the industrial equipment can be provided in the virtual environment in response to the selection device.

FIG. 26 is an example of a method 2600 for using a VR training tool, for example the VR training tool 114, as shown in FIG. 1. Thus, reference can be made to the example of FIGS. 1-24 in the example of FIG. 26. The method 2600 can begin at 2602 by a user (e.g., the user 206, as shown in FIG. 2) logging into a simulation that includes a virtual environment (e.g., the virtual environment 204, as shown in FIG. 2) using a selection device (e.g., the selection device 106, as shown in FIG. 1). The VR simulation for the virtual environment can be generated based on virtual environment data (e.g., the virtual environment data 124, as shown in FIG. 1). At 2604, the user can select a mode of operation for the virtual environment. For example, the user at 2604 can select either a single or multiple mode of operation for the virtual environment. At 2606, a plant of a number of plants identified in the virtual environment can be selected for training. For example, the user can interact with a kiosk (e.g., the kiosk 302, as shown FIG. 3) provided in the virtual environment using the selection device. At 2608, the user can select one or more industrial equipment (e.g., the equipment 304, as shown in FIG. 3) for training using the selection device. The user can use the kiosk to select the one or more industrial equipment from a list of a number of industrial equipment for the selected plant.

In some examples, at 2610, the user can use the selection device to provide in the virtual environment equipment description, which can be rendered on the kiosk. In some examples, at 2612, a model of the one or more selected equipment can be provided in the virtual environment. In some instances, a number of graphical user elements can be provided in the virtual environment with which the user can interact to learn about the one or more selected equipment. Each graphical user element can provide the user with a different learning approach or style for understanding how the one or more selected equipment behaves, operates, functions, fits into a process flow, etc.

For example, at 2614, a cut-away graphical element can be provided in the virtual environment (e.g., on the kiosk), which the user can use to visualize internal features or characteristics of the one or more industrial equipment. In some instances, at 2616, a scale in size graphical element can be provided in the virtual environment (e.g., on the kiosk), which the user can use to change a size of the model of the industrial equipment, thereby permitting the user to visualize the model of the industrial equipment in miniature form. In additional or alternative examples, at 2618, a comparison graphical element can be provided in the virtual environment, which can provide a picture or an image of the industrial equipment next to the model of the industrial equipment so that the user can see the industrial equipment in a real-world context. In some examples, at 2620, an audio graphical element can be provided in the virtual environment (e.g., on the kiosk), which the user can interact with for a narration of the equipment description. In some instances, a process view graphical element can be provided in the virtual environment (e.g., on the kiosk). The process view graphical element can be interacted with to provide the user with a process view flow in the virtual environment showing the one or more equipment in a corresponding plant process.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

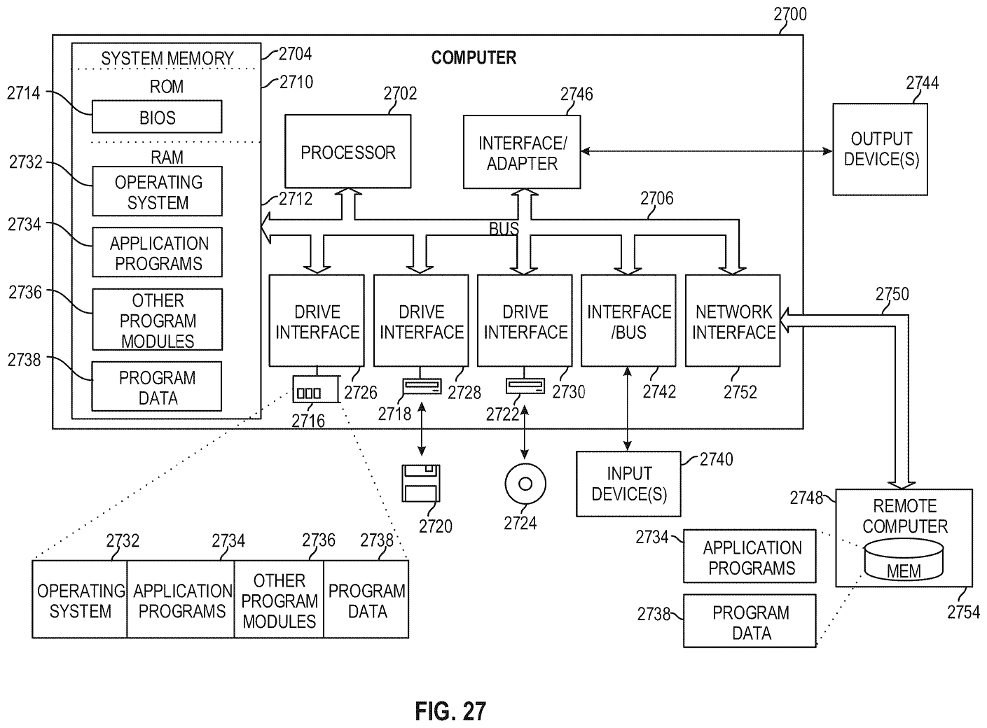

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 27. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 27 illustrates one example of a computer system 2700 that can be employed to execute one or more embodiments of the present disclosure. Computer system 2700 can be implemented on one or more general purpose networked computer systems, embedded computer systems, routers, switches, server devices, client devices, various intermediate devices/nodes or standalone computer systems. Additionally, computer system 2700 can be implemented on various mobile clients such as, for example, a personal digital assistant (PDA), laptop computer, pager, and the like, provided it includes sufficient processing capabilities.

Computer system 2700 includes processing unit 2702, system memory 2704, and system bus 2706 that couples various system components, including the system memory 2704, to processing unit 2702. Dual microprocessors and other multi-processor architectures also can be used as processing unit 2702. System bus 2706 may be any of several types of bus structure including a memory bus or memory controller, a peripheral bus, and a local bus using any of a variety of bus architectures. System memory 2704 includes read only memory (ROM) 2710 and random access memory (RAM) 2712. A basic input/output system (BIOS) 2714 can reside in ROM 2710 containing the basic routines that help to transfer information among elements within computer system 2700.

Computer system 2700 can include a hard disk drive 2716, magnetic disk drive 2718, e.g., to read from or write to removable disk 2720, and an optical disk drive 2722, e.g., for reading CD-ROM disk 2724 or to read from or write to other optical media. Hard disk drive 2716, magnetic disk drive 2718, and optical disk drive 2722 are connected to system bus 2706 by a hard disk drive interface 2726, a magnetic disk drive interface 2728, and an optical drive interface 2730, respectively. The drives and associated computer-readable media provide nonvolatile storage of data, data structures, and computer-executable instructions for computer system 2700. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 2710, including operating system 2732, one or more application programs 2734, other program modules 2736, and program data 2738. In some examples, the application programs 2734 can include rendering system 118 and the program data 2738 can include the virtual environment data 124, as shown in FIG. 1. The application programs 2734 and program data 2738 can include functions and methods programmed for generating a simulation of a virtual environment and corresponding training according to the examples described herein.

A user may enter commands and information into computer system 2700 through one or more input devices 2740, such as a pointing device (e.g., a mouse, touch screen), keyboard, microphone, joystick, game pad, scanner, and the like. These and other input devices are often connected to processing unit 2702 through a corresponding port interface 2742 that is coupled to the system bus, but may be connected by other interfaces, such as a parallel port, serial port, or universal serial bus (USB). One or more output devices 2744 (e.g., display, a monitor, printer, projector, or other type of displaying device) is also connected to system bus 2706 via interface 2746, such as a video adapter.

Computer system 2700 may operate in a networked environment using logical connections to one or more remote computers, such as remote computer 2748. Remote computer 2748 may be a workstation, computer system, router, peer device, or other common network node, and typically includes many or all the elements described relative to computer system 2700. The logical connections, schematically indicated at 2750, can include a local area network (LAN) and a wide area network (WAN). When used in a LAN networking environment, computer system 2700 can be connected to the local network through a network interface or adapter 2752. When used in a WAN networking environment, computer system 2700 can include a modem, or can be connected to a communications server on the LAN. The modem, which may be internal or external, can be connected to system bus 2706 via an appropriate port interface. In a networked environment, application programs 2734 or program data 2738 depicted relative to computer system 2700, or portions thereof, may be stored in a remote memory storage device 2754.

The invention claimed is:

1. A method for industrial virtual training, the method comprising:
providing, on a device, a simulation that includes a virtual environment;
in response to user selection on a selection device:
selecting a mode of operation for the virtual environment;
selecting an industrial plant;
identifying industrial equipment in the virtual environment;
rendering a model of the industrial equipment in the virtual environment; and
providing equipment description.

2. The method of claim 1, further comprising logging into the simulation that includes the virtual environment in response to user selection on the selection device, the mode of operation for the virtual environment being selected in response to the logging into the simulation, and the mode of operation is one of a single mode or multi-mode of operation.

3. The method of claim 2, wherein the virtual environment includes a model of a kiosk with which a user can interact to select the mode of operation and the industrial plant for industrial training of the industrial equipment using the selection device.

4. The method of claim 3, wherein the industrial equipment is selected from a list of a number of industrial equipment identified on the model of the kiosk in response to the user selection on the selection device.

5. The method of claim 4, wherein the equipment description in the virtual environment is one of provided on the model of the kiosk or provided as part of a detail graphical element in the virtual environment in proximity to the model of the industrial equipment.

6. The method of claim 1, further comprising providing a number of graphical interactive elements in the virtual environment for interaction using the selection device to provide a different learning style for understanding how the industrial equipment behaves, operates, functions, and/or fits into a process flow.

7. The method of claim 6, wherein the number of graphical interactive elements includes one of:
a cut-away graphical element for interaction using the selection device to provide an internal view into the model of the industrial equipment; and
a scale in size graphical element for interaction using the selection device to change a size of the model of the industrial equipment from a given size to a different size.

8. The method of claim 6, wherein the number of graphical interactive elements includes one of:
a comparison graphical element for interaction using the selection device to provide a picture or an image of the industrial equipment in proximity to the model of the industrial equipment; and
an audio graphical element for interaction using the selection device to provide a narration of the equipment description for the industrial equipment.

9. The method of claim 6, wherein number of graphical interactive elements includes a process view graphical element for interaction using the selection device to update the virtual environment with a process view flow for visualizing the industrial equipment in a corresponding plant process flow.

10. The method of claim 6, wherein the virtual environment is generated based on virtual environment data provided by a rendering system.

11. The method of claim 6, further comprising:
providing instructions and content, using a rendering controller of the rendering system, from a content repository for simulating the virtual environment; and
running the instructions and the content, using a gaming engine, to simulate the virtual environment, wherein the rendering controller is configured to receive selection requests from the selection device and an update virtual environment based on the selection requests.

12. The method of claim 11, further comprising causing an electronic display to provide the virtual environment in one of a first-person view and a spectator view, wherein the virtual environment includes a virtual camera to provide one of the first-person view and the spectator view.

13. The method of claim 6, further comprising:
receiving a package build that includes data representative of the virtual environment; and
causing the package build to be executed on the device to simulate the virtual environment.

14. A system for virtual industrial training comprising:
a rendering system comprising:
a rendering controller configured to provide instructions and content from a content repository for simulating a virtual environment; and
a game engine configured to run the instructions and the content to simulate the virtual environment with one or models of an industrial plant and/or equipment, wherein the rendering controller is configured to receive user selection requests from one or more selection devices and update the virtual environment to allow a user to learn about the industrial plant and/or equipment.

15. The system of claim 14, further comprising a mobile device with an electronic display for providing a view into the virtual environment, wherein the view is one of a first-person view and a spectator-view.

16. The system of claim 15, wherein the virtual environment includes a virtual camera to provide a point of view in the virtual environment corresponding to one of the first-person view and the spectator view.

17. The system of claim 16, wherein the mobile device is a virtual reality (VR) headset.

18. A non-transitory computer-readable medium comprising machine-readable instructions representative of a package build that includes a virtual environment, which, when executed by a processor cause the processor to:
simulate the virtual environment;
receive a mode of operation for the virtual environment;
identify a plant of a number of plants for industrial training;
identify industrial equipment of the identified plant;
provide the virtual environment with a model of the identified industrial equipment; and
provide equipment description for the industrial equipment in the virtual environment.

19. The non-transitory computer-readable medium of claim 18, wherein the machine-readable instructions when executed by the processor cause the processor further to determine a mode of operation for the virtual environment, the mode of operation corresponding to one of a single-mode and a multi-mode of operation, and wherein the virtual environment is provided in a first-person view based on the single-mode, and in a spectator view based on the multi-mode of operation.

20. The non-transitory computer-readable medium of claim 19, wherein the machine-readable instructions when executed by the processor cause the processor further to provide a number of graphical user elements in the virtual environment for interaction based on a user selection in response to a selection device to provide a different learning style for understanding how the identified industrial equipment behaves, operates, functions, and/or fits into a process flow.
